(19) United States
(12) Patent Application Publication
(10) Pub. No.: US 2022/0013272 A1
(43) Pub. Date: Jan. 13, 2022

(54) MOLDED TRANSFORMER

(71) Applicant: Sanil Electric Co., Ltd., Gyeonggi-do (KR)

(72) Inventors: Dong Suk PARK, Seoul (KR); Sung Il PARK, Gyeonggi-do (KR)

(73) Assignee: Sanil Electric Co., Ltd., Gyeonggi-do (KR)

(21) Appl. No.: 17/177,870

(22) Filed: Feb. 17, 2021

(30) Foreign Application Priority Data
Jul. 9, 2020 (KR) 10-2020-0084637

(51) Int. Cl. H01F 27/02; H01F 27/32

(52) U.S. Cl. CPC H01F 27/02; H01F 27/32

(57) ABSTRACT

A molded transformer is disclosed. The molded transformer includes a first body case, a second body case engaged with the first body case, an adhesive agent applied to the periphery of the engagement portion between the first and second body cases, coil layers provided inside the first and second body cases and spaced apart from each other at regular intervals, with coil support blocks interposed therebetween, an integral-type coil support engaged with the lower end portion of the second body case in order to support the coil layers, a lower support engaged with the integral-type coil support and seated on the ground, a height adjustment unit engaged with the lower surface of the integral-type coil support while penetrating the lower support in order to adjust the height of the integral-type coil support, and a tap changer provided on the side surfaces of the first and second body cases.

This application claims the benefit of Korean Patent Application No. 10-2020-0084637, filed on Jul. 9, 2020 which is hereby incorporated by reference as if fully set forth herein.

### BACKGROUND OF THE INVENTION

### Field of the Invention

The present invention relates to a molded transformer, and more particularly to a molded transformer that is manufactured at low cost, has a reduced weight, and exhibits improved cooling performance by lowering a temperature using air circulation.

### Discussion of the Related Art

An autotransformer currently used in electric railways is a power conversion device that is of a paper insulation type using an A-class insulation material and supplies power to a railway power line. Such an autotransformer is one of the most important devices in the railway technology field.

However, autotransformers have problems in which the load amount changes irregularly and overload frequently occurs, thus causing overheating and promoting deterioration, resulting in fires attributable to dielectric breakdown.

Further, currently produced autotransformers have poor insulation and short-circuit prevention characteristics, which adversely affect the lifespan of autotransformers. Therefore, improvement of the quality thereof is urgently required.

Meanwhile, molded transformers have been proposed to solve the problems with oil-immersed transformers, e.g. the risk of fire and explosion in the event of an accident. Molded transformers are structured such that windings are molded with epoxy resin, which has excellent insulation and flame retardancy characteristics, and such that a high-voltage winding and a low-voltage winding are isolated from each other. Accordingly, the heat dissipation area is large, and even if an electric arc occurs in windings, there is no risk of ignition. Further, even if a fire occurs, molded transformers self-extinguish.

However, the conventional molded transformers described above have problems in which they are difficult to manufacture due to the large size thereof and in which the weight thereof is large and the cooling performance thereof is poor due to provision of an upper coil support block, a lower coil support block, and a lower support unit.

### SUMMARY OF THE INVENTION

Therefore, the present invention has been made in view of the above problems, and it is an object of the present invention to provide a molded transformer in which a body case is formed in a multi-stage separation type and an integral-type coil support combined with a lower support is provided, thereby enabling elimination of an upper coil support block, thus reducing the manufacturing costs and weight thereof and exhibiting improved cooling performance.

In accordance with the present invention, the above and other objects can be accomplished by the provision of a molded transformer including first and second body cases engaged with each other, one of which includes a concave portion formed in an engagement surface thereof and the other one of which includes a convex portion formed on an engagement surface thereof so as to be fitted into the concave portion, an adhesive agent applied to the periphery of the engagement portion between the first and second body cases, coil layers provided inside the first and second body cases and spaced apart from each other at regular intervals, with coil support blocks interposed therebetween, an integral-type coil support engaged with the lower end portion of the second body case in order to support the coil layers, a lower support engaged with the integral-type coil support and seated on the ground, a height adjustment unit engaged with the lower surface of the integral-type coil support while penetrating the lower support in order to adjust the height of the integral-type coil support, and a tap changer provided on the side surfaces of the first and second body cases.

The lower support may include a concave portion formed therein so that the integral-type coil support is seated therein. The first body case may include a round-shaped convex portion, and the second body case may include a round-shaped concave portion.

The height adjustment unit may include a bolt and a nut in order to adjust the height of the integral-type coil support. The integral-type coil support may include support legs protruding a predetermined height in the state of being spaced a predetermined interval apart from each other so as to be seated in the concave portion in the lower support, and a fastening hole may be formed to a predetermined depth in the center of the lower surface of each of the support legs. The fastening hole may be a threaded hole having a predetermined thread handedness.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a plan view schematically showing a molded transformer according to the present invention;

FIG. 2 is a plan view showing a body case of the molded transformer shown in FIG. 1;

FIG. 3 is a view showing the integral-type coil support shown in FIG. 1 in more detail; and

FIG. 4 is a view showing the coil layer and the coil support block shown in FIG. 1.

### DETAILED DESCRIPTION OF THE INVENTION

Hereinafter, embodiments of the present invention will be described in more detail with reference to the accompanying drawings. Here, it is noted that the same element in the accompanying drawings is denoted as the same reference numeral as far as possible. The detailed description of known function and construction unnecessarily obscuring the subject matter of the present invention will be omitted.

Terms used in the following description are used only to describe the specific embodiments and are not intended to restrict the present invention. The expression of singularity includes a plural meaning unless the singularity expression is explicitly different in context. In the specification, the terms “comprising,” “including,” and “having” shall be understood to designate the presence of particular features, numbers, steps, operations, elements, parts, Or combinations thereof but not to preclude the presence or addition of one or more other features, numbers, steps, operations, elements, parts, or combinations thereof.

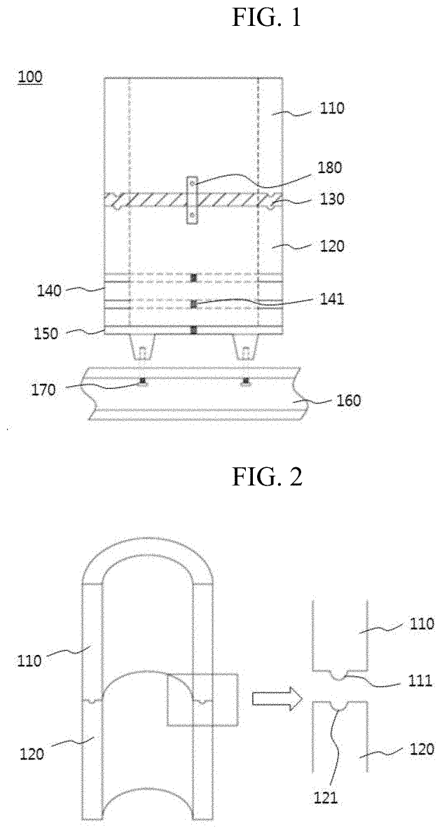

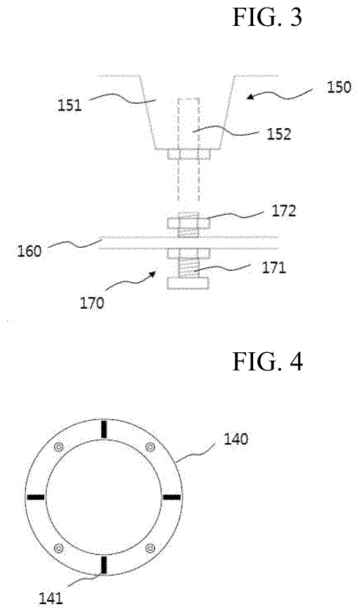

FIG. 1 is a plan view schematically showing a molded transformer according to the present invention, FIG. 2 is a plan view showing a body case of the molded transformer shown in FIG. 1, FIG. 3 is a view showing the integral-type coil support shown in FIG. 1 in more detail, and FIG. 4 is a view showing the coil layer and the coil support block shown in FIG. 1.

As shown in FIGS. 1 to 4, a molded transformer 100 according to the present invention includes first and second body cases 110 and 120 engaged with each other, one of which includes a concave portion 121 formed in an engagement surface thereof and the other one of which includes a convex portion 111 formed on an engagement surface thereof so as to be fitted into the concave portion 121, an adhesive agent 130 applied to the periphery of the engagement portion between the first and second body cases 110 and 120, a plurality of coil layers 140 provided inside the first and second body cases 110 and 120 and spaced apart from each other at regular intervals, with coil support blocks 141 interposed therebetween, an integral-type coil support 150 engaged with the lower end portion of the second body case 120 in order to support the coil layers 140, a lower support 160 engaged with the integral-type coil support 150 and seated on the ground, a height adjustment unit 170 engaged with the lower surface of the integral-type coil support 150 while penetrating the lower support 160 in order to adjust the height of the integral-type coil support 150, and a tap changer 180 provided on the side surfaces of the first and second body cases 110 and 120.

The first body case 110, which is located on the second body case 120, includes a convex portion 111 formed along the center of the annular-shaped lower surface thereof while protruding a predetermined height therefrom. The second body case 120, which is located under the first body case 110, includes a concave portion 121 formed along the center of the annular-shaped upper surface thereof while being recessed a predetermined depth therein so as to correspond to the convex portion 111 of the first body case 110.

When the first and second body cases 110 and 120 are engaged with each other, the adhesive agent 130 is applied to the periphery of the engagement portion therebetween, thereby preventing separation of the first and second body cases 110 and 120 from each other.

The adhesive agent 130 is an insulation layer including a bonding material. Since any adhesive agent capable of bonding the first and second body cases 110 and 120 to each other can be used as the insulation adhesive agent, the embodiment is not limited as to the specific type of insulation adhesive agent. For example, the insulation adhesive agent may be implemented as an epoxy adhesive agent or a ceramic adhesive agent, which is made of a material that can be used at a high temperature, i.e. a thermosetting-resin-based material, and has excellent heat resistance and insulating properties. In addition, the insulation adhesive agent may be applied to the steel sheet in various manners. For example, the insulation adhesive agent may be formed by stacking insulation adhesive layers using a groove roll.

The coil layer 140 may be formed by winding coils around a sheet conductor. The periphery of the coil layer 140 may be imparted with insulating properties using a pre-preg insulated sheet.

The coil layer 140 is formed by winding a high-voltage coil and a low-voltage coil around a core forming a magnetic circuit, thereby forming an electric circuit.

The core may be formed by laminating silicon steel plates in order to reduce eddy current loss therein, and may be formed in various shapes. When the magnetic flux in the core changes over time, eddy current loss and hysteresis loss occur. The silicon content in iron and an annealing process are important factors in determining hysteresis loss.

In general, when the silicon content increases, the magnetic permeability and electrical resistance increase, and thus a high-quality magnetic material is formed. However, when the silicon content exceeds 4%, the material is fragile, and the processability thereof is deteriorated. In the embodiment of the present invention, since the portion of the core that is to be processed is small, a high silicon steel sheet having a silicon content of about 4% is used.

The coil layer 140 is divided into two parts, i.e. a high-voltage winding and a low-voltage winding, and an aluminum sheet, which has a thermal expansion coefficient similar to that of epoxy resin, is used as the conductor. The high-voltage winding and the low-voltage winding are molded with epoxy resin, and are disposed concentrically on the core. A cooling duct may be provided between the high-voltage winding and the low-voltage winding in order to effectively dissipate heat from the windings.

The lower support 160 has a concave portion formed therein in the longitudinal direction so that the integral-type coil support 150 is seated therein. The concave portion 121 formed in the second body case 120 has a round shape. In this case, the convex portion 111 formed on the first body case 110 also has a round shape.

The lower support 160 is a member that is seated on the bottom surface on which the plurality of coil layers 140 is installed, i.e. the bottom surface of the place where the molded transformer 100 is installed. Preferably, the lower support 160 may be two in number, that is, may be provided in a pair, which may be disposed parallel to each other with a predetermined interval therebetween. However, the number of lower supports 160 is not limited to two, and a greater number of lower supports, e.g. three or more lower supports, may be provided.

The integral-type coil support 150 is coupled to the upper portion of the lower support 160, and is configured to support the lower portions of the plurality of coil layers 140.

The integral-type coil support 150 has support legs 151, which protrude a predetermined height in the state of being spaced a predetermined interval apart from each other so as to be seated in the concave portion in the lower support 160. A fastening hole 152 is formed to a predetermined depth in the center of the lower surface of each support leg 151. The fastening hole 152 is a threaded hole having a predetermined thread handedness.

The lower support 160 has a through-hole (not shown) formed therein corresponding to the fastening hole 152 in the integral-type coil support 150.

The height adjustment unit 170 is composed of a bolt 171 and a nut 172 in order to adjust the height of the integral-type coil support 150.

The bolt 171 penetrates the through-hole in the lower support 160 from the below the lower support 160, and is then fastened into the fastening hole 152. When the bolt 171 is fastened to a predetermined depth, the nut 172 is rotated so as to be fixed to the lower support 160. The nut 172 may be two in number, with the lower support 160 interposed therebetween, in order to tightly fix the bolt 171.

Meanwhile, the molded transformer 100 according to the present invention may be a three-phase molded transformer, and may have a structure including a core and three coils arranged in a row in the longitudinal direction of the core. The molded transformer 100 shown herein is a three-phase molded transformer including three cores, but the embodiment is not limited thereto. Although not shown separately, the coils may be one or two in number.

The tap changer 180 is provided with primary terminals, to which a primary voltage is applied, and a secondary terminal, to which a secondary voltage is applied. The primary terminals are connected via an interphase lead for connection, and tap voltage is changed at an appropriate position on the outer surface of the coil assembly.

That is, the tap changer 180 is device for setting a required load voltage by adjusting tap positions in the primary winding when the load voltage in the secondary winding is high or low, and performs a change after the power is shut off.

Meanwhile, although not shown in the drawings, in the embodiment of the present invention, a temperature-sensing device for measuring the temperature of the windings in the molded transformer 100 may be mounted in the molded transformer 100 in order to detect and announce an abnormal temperature and to interrupt the circuit. In addition, the molded transformer 100 may be provided with a wireless communication system for remote monitoring, thereby enabling an operator or manager at a remote location to check whether or not the molded transformer operates normally.

As is apparent from the above description, a molded transformer according to the embodiment of the present invention has the following effects.

First, since a body case is formed in a multi-stage separation type and an integral-type coil support combined with a lower support is provided, an upper coil support block is eliminated, thus reducing the manufacturing costs and overall weight thereof.

Second, since an upper coil support block is eliminated, the overall height of a core may be reduced, and accordingly, the manufacturing costs and weight thereof may be reduced.

Third, since an upper coil support block is eliminated, air may circulate in a corresponding space, thereby lowering a temperature, thus improving cooling performance.

Fourth, since a height adjustment unit is provided between a lower support and an integral-type coil support, it is possible to level the transformer.

Fifth, since a body case is formed in a multi-stage separation type, when a coil is damaged due to abnormal operation after installation of the transformer, it is possible to replace only the damaged coil, thereby minimizing expenses related to the damage.

Although the present invention has been described with reference to the preferred embodiments, it is to be understood that various modifications or changes can be made without departing from the technical spirit and the scope of the invention as disclosed in the accompanying claims by those skilled in the art. Therefore, the scope of the present invention should be interpreted by the following claims, which have been set forth so as to include such various changes.

What is claimed is:

1. A molded transformer, comprising:
a first body case;
a second body case engaged with the first body case,
wherein one of the first body case and the second body case comprises a concave portion formed in an engagement surface thereof and a remaining one of the first body case and the second body case comprises a convex portion formed on an engagement surface thereof so as to be fitted into the concave portion;
an adhesive agent applied to a periphery of an engagement portion between the first body case and the second body case;
coil layers provided inside the first body case and the second body case and spaced apart from each other at regular intervals, with coil support blocks interposed therebetween;
an integral-type coil support engaged with a lower end portion of the second body case to support the coil layers;
a lower support engaged with the integral-type coil support and seated on a ground;
a height adjustment unit engaged with a lower surface of the integral-type coil support while penetrating the lower support, the height adjustment unit being configured to adjust a height of the integral-type coil support; and
a tap changer provided on side surfaces of the first body case and the second body case.

2. The molded transformer according to claim 1, wherein the lower support comprises a concave portion formed therein so that the integral-type coil support is seated therein.

3. The molded transformer according to claim 1, wherein the first body case comprises a round-shaped convex portion, and
wherein the second body case comprises a round-shaped concave portion.

4. The molded transformer according to claim 1, wherein the height adjustment unit comprises a bolt and a nut to adjust a height of the integral-type coil support.

5. The molded transformer according to claim 1, wherein the integral-type coil support comprises support legs protruding a predetermined height in a state of being spaced a predetermined interval apart from each other so as to be seated in a concave portion in the lower support,
wherein a fastening hole is formed to a predetermined depth in a center of a lower surface of each of the support legs, and
wherein the fastening hole is a threaded hole having a predetermined thread handedness.
